(19) United States
(12) Patent Application Publication
(10) Pub. No.: US 2008/0244189 A1
(43) Pub. Date: Oct. 2, 2008

(54) Method, Apparatus, System and Program Product Supporting Directory-Assisted Speculative Snoop Probe With Concurrent Memory Access

(76) Inventors: Brian D. Allison, Rochester, MN (US); Wayne M. Barrett, Rochester, MN (US); Philip R. Hillier, Rochester, MN (US); Kenneth M. Valk, Rochester, MN (US); Brian T. Vanderpool, Byron, MN (US)

Correspondence Address: IBM CORPORATION, 3605 HIGHWAY 52 NORTH, DEPT 917, ROCHESTER, MN, 55901-7829, US

(21) Appl. No.: 11/693,809

(22) Filed: Mar. 30, 2007

(51) Int. Cl. G06F 12/00

(52) U.S. Cl. 711/141; 711/146

(57) ABSTRACT

A multiprocessor data processing system includes a memory controller controlling access to a memory subsystem, multiple processor buses coupled to the memory controller, and at least one of multiple processors coupled to each processor bus. In response to receiving a first read request of a first processor via a first processor bus, the memory controller initiates a speculative access to the memory subsystem and a lookup of the target address in a central coherence directory. In response to the central coherence directory indicating that a copy of the target memory block is cached by a second processor, the memory controller transmits a second read request for the target address on a second processor bus. In response to receiving a clean snoop response to the second read request, the memory controller provides to the first processor the target memory block retrieved from the memory subsystem by the speculative access.

### BACKGROUND OF THE INVENTION

1. Technical Field

The present invention relates in general to data processing and, in particular, to cache coherent multiprocessor data processing systems employing directory-based coherency protocols.

2. Description of the Related Art

In one conventional multiprocessor computer system architecture, a Northbridge memory controller supports the connection of multiple processor buses, each of which has a one or more sockets supporting the connection of a processor. Each processor typically includes an on-die multi-level cache hierarchy providing low latency access to memory blocks that are likely to be accessed. The Northbridge memory controller also includes a memory interface supporting connection of system memory (e.g., Dynamic Random Access Memory (DRAM)).

A coherent view of the contents of system memory is maintained in the presence of potentially multiple cached copies of individual memory blocks distributed throughout the computer system through the implementation of a coherency protocol. The coherency protocol, for example, the well-known Modified, Exclusive, Shared, Invalid (MESI) protocol, entails maintaining state information associated with each cached copy of a memory block and communicating at least some memory access requests between processors to make the memory access requests visible to other processors.

As is well known in the art, the coherency protocol may be implemented either as a directory-based protocol having a generally centralized point of coherency (i.e., the memory controller) or as a snoop-based protocol having distributed points of coherency (i.e., the processors). Because a directory-based coherency protocol reduces the number of processor memory access requests must be communicated to other processors as compared with a snoop-based protocol, a directory-based coherency protocol is often selected in order to preserve bandwidth on the processor buses.

In most implementations of the directory-based coherency protocols, the coherency directory maintained by the memory controller is somewhat imprecise, meaning that the coherency state recorded at the coherency directory for a given memory block may not precisely reflect the coherency state of the corresponding cache line at a particular processor at a given point in time. Such imprecision may result, for example, from a processor “silently” deallocating a cache line without notifying the coherency directory of the memory controller. The coherency directory may also not precisely reflect the coherency state of a cache line at a processor at a given point in time due to latency between when a memory access request is received at a processor and when the resulting coherency update is recorded in the coherency directory. Of course, for correctness, the imprecise coherency state indication maintained in the coherency directory must always reflect a coherency state sufficient to trigger the communication necessary to maintain coherency, even if that communication is in fact unnecessary for some dynamic operating scenarios. For example, assuming the MESI coherency protocol, the coherency directory may indicate the E state for a cache line at a particular processor, when the cache line is actually S or I. Such imprecision may cause unnecessary communication on the processor buses, but will not lead to any coherency violation.

The present invention recognizes that a significant challenge in designing a multiprocessor computer system implementing a directory-based coherency protocol is minimizing the latency of memory access requests while maintaining coherency in the presence of the imprecision inherent the directory-based protocol.

### SUMMARY OF THE INVENTION

In view of the foregoing, the present invention provides improved methods, apparatus, systems and program products. In one embodiment, a multiprocessor data processing system includes a memory controller controlling access to a memory subsystem, multiple processor buses coupled to the memory controller, and at least one of multiple processors coupled to each processor bus. In response to receiving a first read request of a first processor via a first processor bus, the memory controller initiates a speculative access to the memory subsystem and a lookup of the target address in a central coherence directory. In response to the central coherence directory indicating that a copy of the target memory block is cached by a second processor, the memory controller transmits a second read request for the target address on a second processor bus. In response to receiving a clean snoop response to the second read request, the memory controller provides to the first processor the target memory block retrieved from the memory subsystem by the speculative access.

All objects, features, and advantages of the present invention will become apparent in the following detailed written description.

### BRIEF DESCRIPTION OF THE DRAWINGS

The novel features believed characteristic of the invention are set forth in the appended claims. However, the invention, as well as a preferred mode of use, will best be understood by reference to the following detailed description of an illustrative embodiment when read in conjunction with the accompanying drawings, wherein:

FIG. 1 is a high level block diagram of an exemplary data processing system in accordance with the present invention;

FIG. 2 is a more detailed block diagram of the chipset coherency unit (CCU) of FIG. 1;

FIG. 3 illustrates an exemplary format of a pending queue (PQ) entry within the CCU of FIG. 2 in accordance with the present invention;

FIGS. 4A-4B together form a flowchart of an exemplary method of processing a memory access request of a processor in accordance with the present invention;

FIG. 5A is a high level logical flowchart of an imprecise method by which collision detection logic detects collisions between memory access requests in accordance with a first embodiment of the present invention;

FIG. 5B is a high level logical flowchart of a precise method by which collision detection logic detects collisions between memory access requests in accordance with a second embodiment of the present invention;

FIG. 6 is a high level logical flowchart of an exemplary method in accordance with the second embodiment of the present invention by which a memory controller performs cleanup operations for an address collision of a memory access request in accordance with the present invention; and

FIG. 7 is a high level logical flowchart of an exemplary method of efficiently performing an eviction from the coherence directory of FIG. 2 in accordance with the present invention.

### DETAILED DESCRIPTION OF ILLUSTRATIVE EMBODIMENT

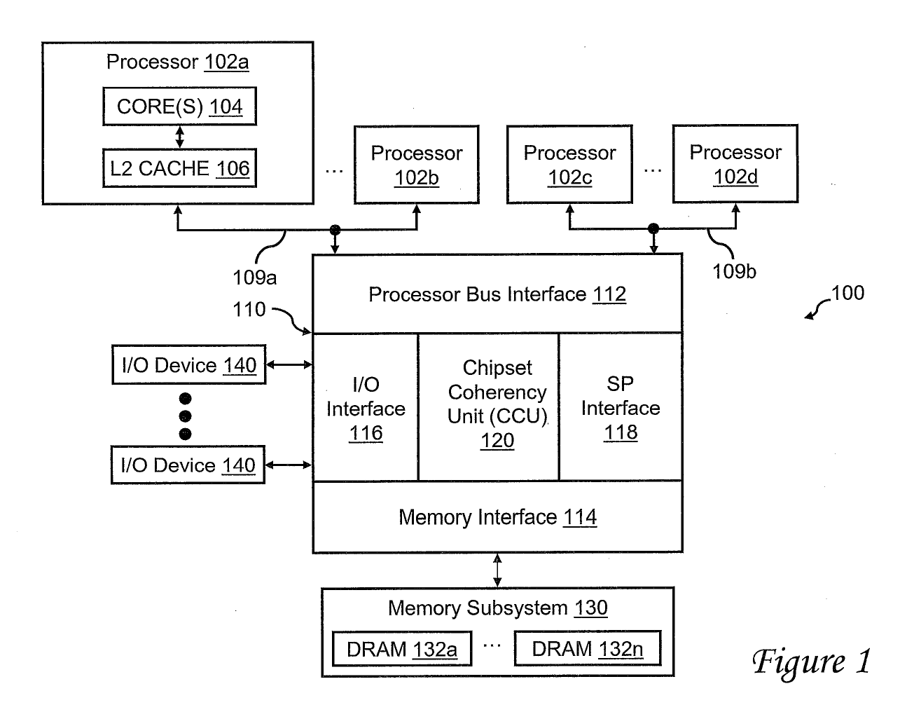

With reference now to the figures, wherein like reference numerals refer to like and corresponding parts throughout, and in particular with reference to FIG. 1, there is illustrated a high-level block diagram depicting an exemplary cache coherent multiprocessor data processing system 100 in accordance with the present invention. As shown, data processing system 100 includes multiple processors 102 (in the exemplary embodiment, at least processors 102a, 102b, 102c and 102d) for processing data and instructions. In the depicted embodiment, processors 102, which are formed of integrated circuitry, each include a level two (L2) cache 106 and one or more processing cores 104 each having an integrated level one (L1) cache (not illustrated). As is well known in the art, L2 cache 106 includes a data array (not illustrated), as well as a cache directory (not illustrated) that maintains coherency state information for each cache line or cache line sector cached within the data array. In an exemplary embodiment, the possible coherency states of cache lines held in L2 cache 106 include the Modified, Exclusive, Shared and Invalid states of the well-known MESI protocol. Of course in other embodiments, other coherency protocols may be employed.

Each processor 102 is further connected to a socket on a respective one of multiple processor buses 109 (e.g., processor bus 109a or processor bus 109b) that conveys address, data and coherency/control information. In one embodiment, communication on each processor bus 109 is governed by a conventional bus protocol that organizes the communication into distinct time-division multiplexed phases, including a request phase, a snoop phase, and a data phase.

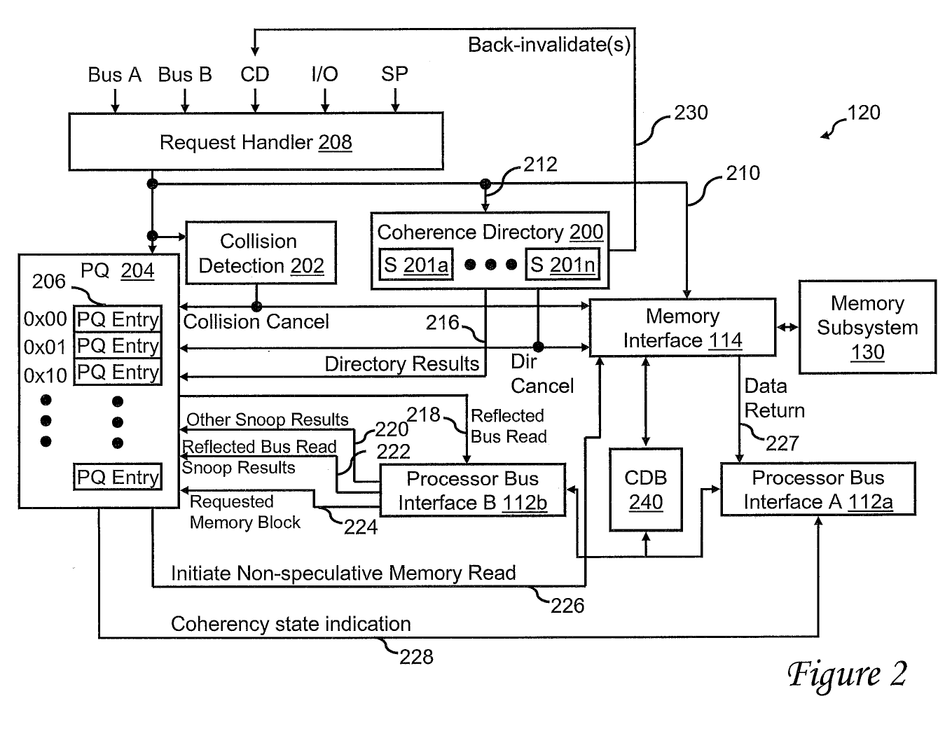

As further depicted in FIG. 1, data processing system 100 further includes a Northbridge memory controller 110. Memory controller 110, which is preferably realized as a single integrated circuit, includes a processor bus interface 112 that is connected to each processor bus 109 and that supports communication with processors 102 via processor buses 109. As indicated in FIG. 2, processor bus interface 112 preferably includes a separate instance of data buffering and bus communication logic (i.e., processor bus interface 112a, 122b) for each processor bus 109. Data received by each processor bus interface 112a, 112b for transmission to a processor 102 is buffered until the data is validated, and is thereafter transmitted to over the appropriate processor bus 109. The data validation may arrive before or after the data to be transmitted.

Memory controller 110 further includes a memory interface 114 that controls access to a memory subsystem 130 containing memory devices such as Dynamic Random Access Memories (DRAMs) 132a-132n, an input/output (I/O) interface 116 that manages communication with I/O devices 140, and a Scalability Port (SP) interface 150 that supports attachment of multiple computer systems to form a large scalable system. Memory controller 110 finally includes a chipset coherency unit (CCU) 120 that maintains memory coherency in data processing system 100 by implementing a directory-based coherency protocol, as discussed below in greater detail.

Those skilled in the art will appreciate that data processing system 100 of FIG. 1 can include many additional non-illustrated components, such as interconnect bridges, non-volatile storage, ports for connection to networks, etc. Because such additional components are not necessary for an understanding of the present invention, they are not illustrated in FIG. 1 or discussed further herein.

Referring now to FIG. 2, a more detailed block diagram of an exemplary embodiment of the chipset coherency unit (CCU) 120 of memory controller 110 of FIG. 1 is depicted with reference to other components of data processing system 100. As shown, CCU 120 includes an coherence directory 200 that records a respective coherency state for each processor 102 in association with the memory address of each memory block cached by any of processors 102 (i.e., coherence directory 200 is inclusive of the contents of L2 caches 106). In an exemplary embodiment, the possible coherency states that may be recorded in coherence directory 200 are only a subset of the possible cache coherency states and include the Exclusive, Shared and Invalid states of the MESI protocol. In practical implementations, coherence directory 200 has fewer entries than the number of memory blocks within the DRAMs 132 of memory subsystem 130, and therefore implements a replacement policy (e.g., random, round-robin, LRU, MRU, etc.) that governs selection of a victim entry within coherence directory 200 when a new entry is needed. Eviction of a victim entry from coherence directory 200 is managed by a sequencer (S) 201 from among a pool of sequencers 201a-201n within coherence directory 200.

CCU 120 further includes collision detection logic 202 that detects and signals collisions between memory access requests and a request handler 208 that serves as a point of serialization for memory access and coherency update requests received by CCU 120 from processor buses 109a, 109b, coherence directory 200, I/O interface 116, and SP 118. CCU 120 also includes a pending queue (PQ) 204 for processing requests. PQ 204 includes a plurality of PQ entries 206 for buffering memory access and coherency update requests until serviced. As indicated, each PQ entry 206 has an associated key (e.g., 0x00, 0x01, 0x10, etc.) uniquely identifying that PQ entry 206. PQ 204 includes logic for appropriately processing the memory access and coherency update requests to service the memory access requests and maintain memory coherency. Finally, CCU 120 includes a central data buffer (CDB) 240 that buffers memory blocks associated with pending memory access requests.

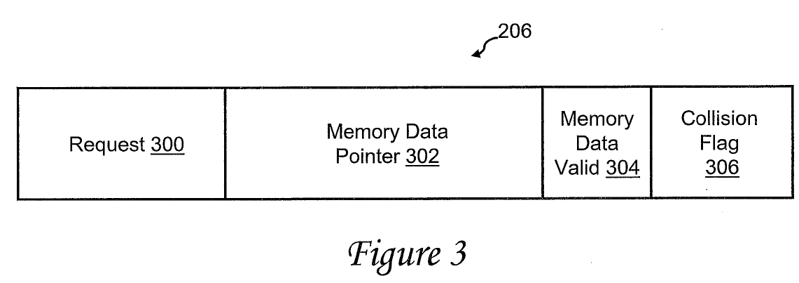

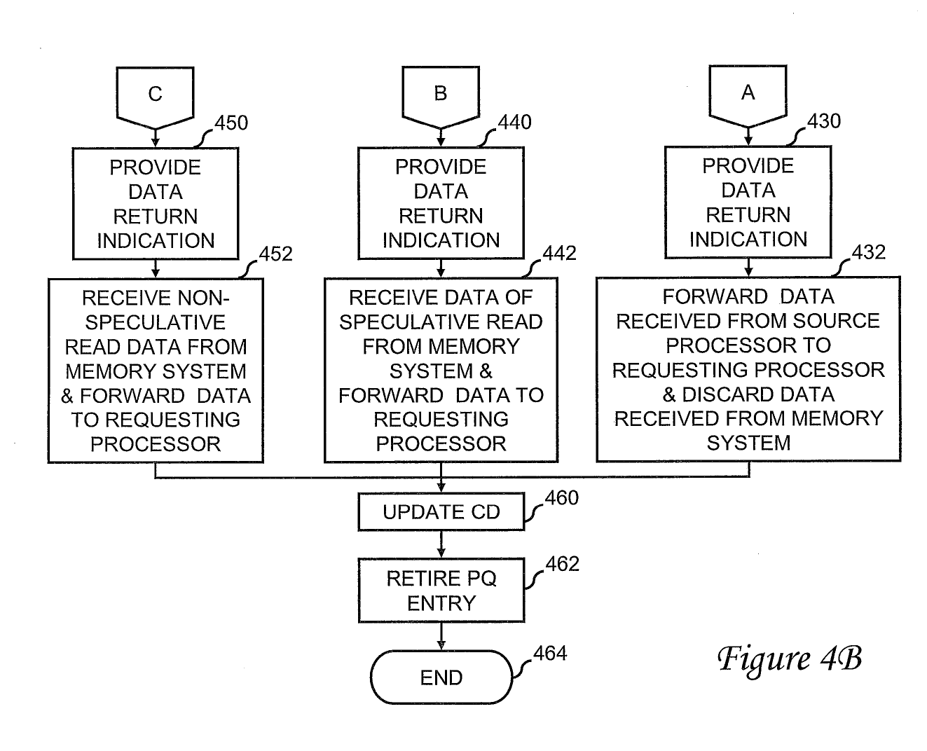

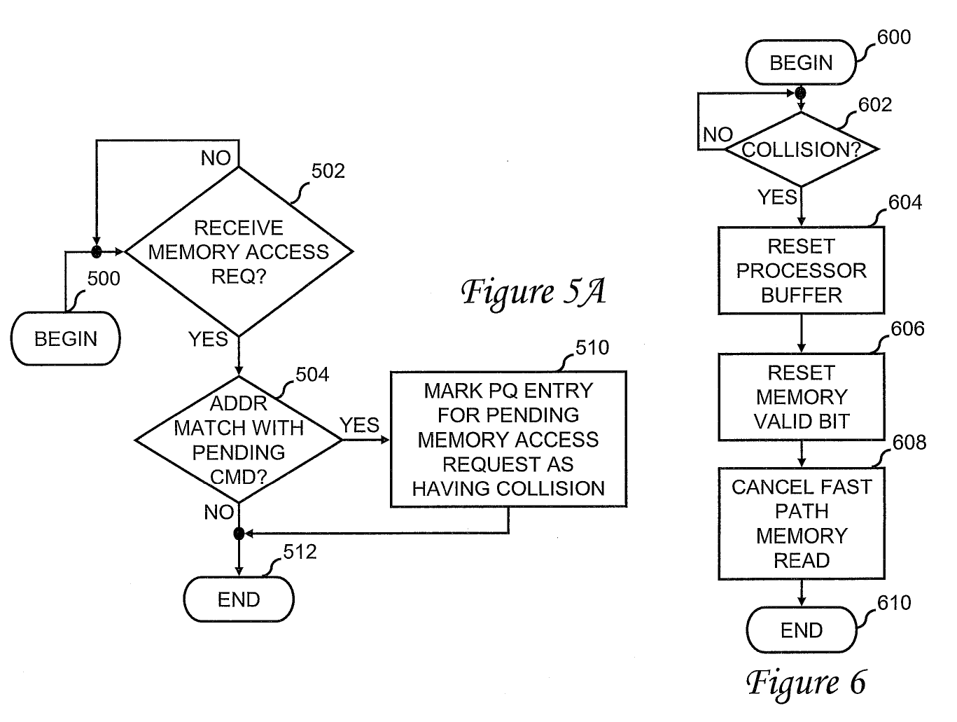

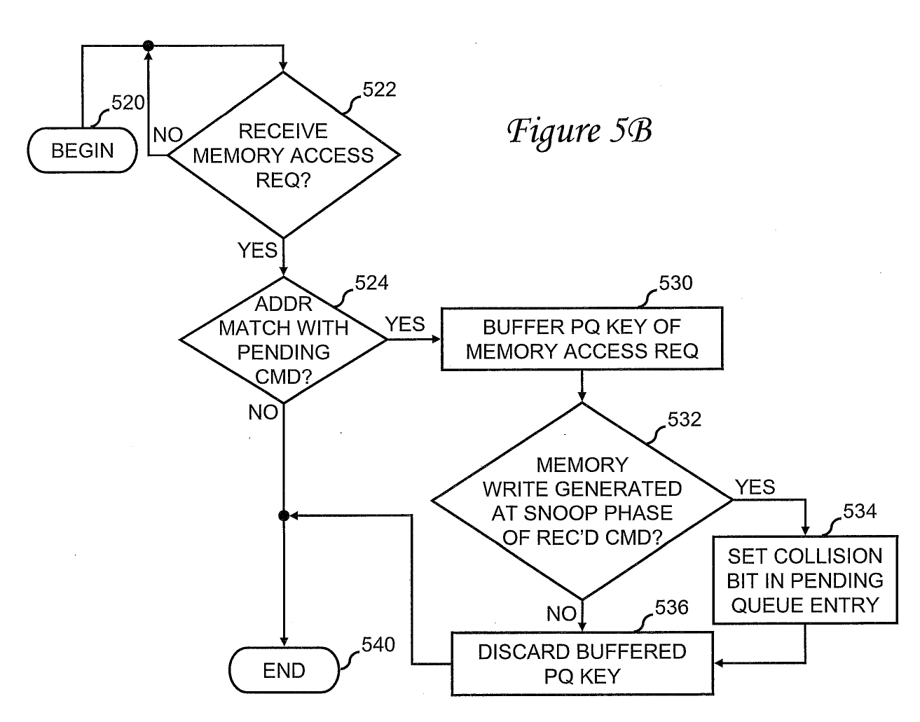

With reference now to FIG. 3, there is illustrated an exemplary embodiment of a pending queue (PQ) entry 206 within CCU 120 of FIG. 2 in accordance with the present invention. In the depicted embodiment, PQ entry 206 includes a request field 300 for buffering the pending memory access or coherency update request to which PQ entry 206 is allocated, a memory data pointer field 302 for identifying a location within a central data buffer (CDB) 240 (see FIG. 2) in which a memory block read from or to be written to memory subsystem 130 by the memory access request is buffered, and a memory data valid field 304 indicating whether or not the content of indicated location within CDB 240 is valid. In at least one embodiment of the present invention described below with reference to FIGS. 5A-5B and 6, PQ entry 206 further includes a collision flag 306 that provides an indication of whether or not an address collision has occurred for the memory access request to which PQ entry 206 is allocated. As described below with reference to FIGS. 5A-5B, the indication provided by collision flag 306 may be either precise or imprecise.

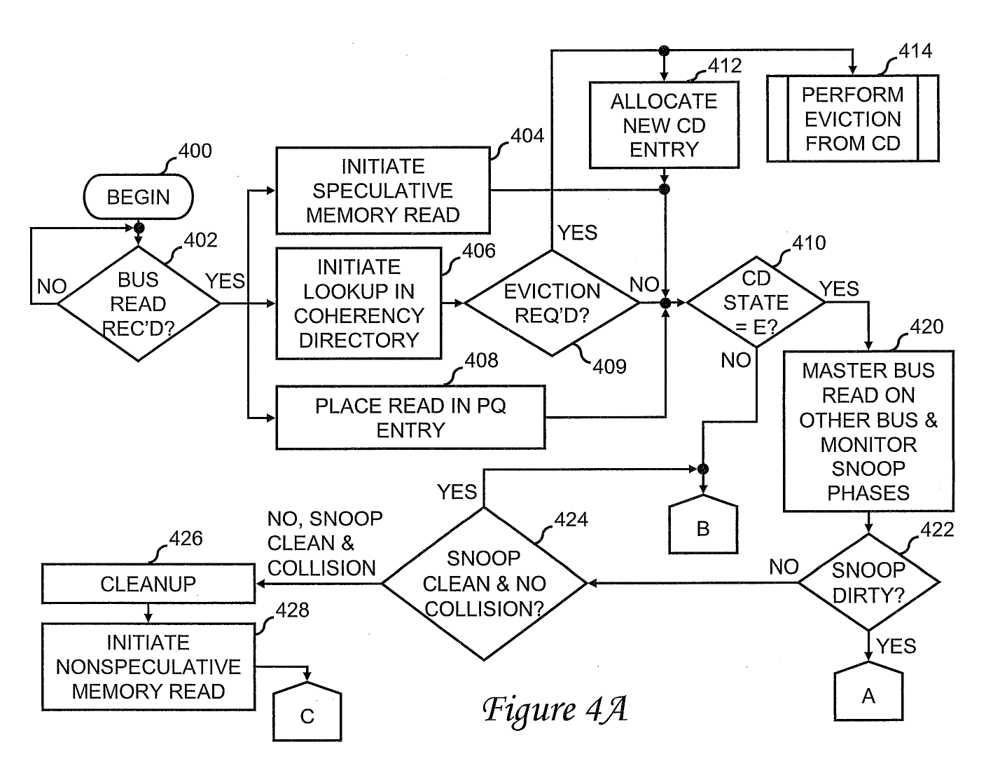

With reference now to FIGS. 4A-4B, there is illustrated a high level logical flowchart of an exemplary method of processing a memory access request (e.g., a bus read request) of a processor in a data processing system 100 in accordance with the present invention. As with the other logical flowcharts described herein, at least some of the illustrated operations may be performed concurrently or in a different order than that depicted.

The illustrated process begins at block 400 and proceeds to block 402, which depicts memory controller 110 determining if it has received a bus read request from a processor 102. If not, the process iterates at block 402 until a bus read request is received. In response to receipt of a bus read request, which includes a transaction type indication and specifies the target memory address of a target memory block to be read, the process proceeds to blocks 404-408. For ease of explanation, it will be assumed hereafter that the bus read request is received by processing bus interface 112a via processor bus 109a.

Block 404 illustrates request handler 208 transmitting the target memory address of the bus read request to memory interface 114 to initiate a speculative (fastpath) read of the memory block associated with the target memory address from memory subsystem 130, as also shown at reference numeral 210 of FIG. 2. The read of the memory block from memory subsystem 130 is speculative in that, in order to mask access latency, the fastpath read is initiated prior to determining whether or not memory subsystem 130 contains the most recent copy of the requested memory block or whether the most recent copy of the memory block is cached by one of processors 102.

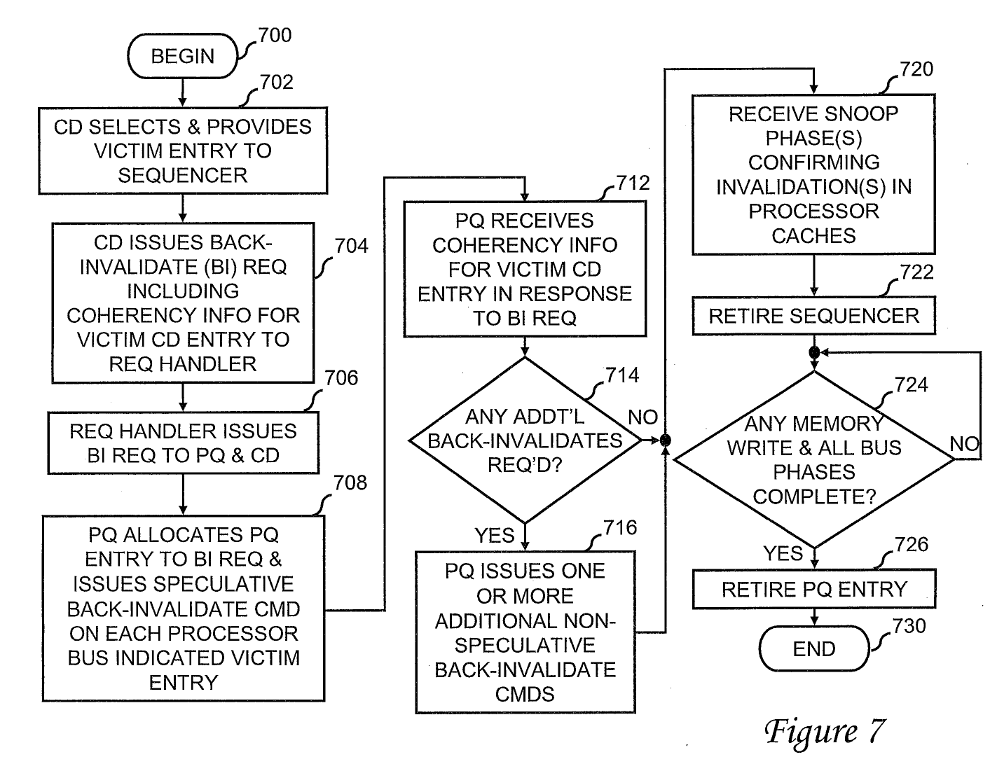

Block 406 depicts request handler 208 transmitting the target memory address of the bus read request to coherence directory 200 to initiate a lookup of the coherency state associated with target memory address in coherence directory 200, as also shown at reference numeral 212 of FIG. 2. If the lookup triggers a miss in coherence directory 200 and an eviction is required to accommodate a new entry for the target memory address (block 409), memory controller 110 allocates a new entry in coherence directory 200 (block 412) and evicts a selected existing entry from coherence directory 200 (block 414). An exemplary process of evicting an entry from coherence directory 200 is described below with reference to FIG. 7. If no miss occurs in coherence directory 200, the process simply proceeds to block 410.

Block 408 illustrates PQ 204 allocating a PQ entry 206 for the memory access request and placing the memory access request in the request field 300 of the allocated PQ entry 206. Allocation of PQ entry 206 associates the memory access request with the key of the allocated PQ entry 206.

The process proceeds from blocks 404,408 and 409 to block 410, which depicts PQ 204 receiving from coherence directory 200 the coherency states of the processors 102 with respect to the target memory address of the memory access request (as also shown at reference numeral 216 of FIG. 2). PQ 204 thereafter processes the memory access request in accordance with the coherency state information in order to service the memory access request while preserving memory coherency. Thus, if PQ 204 determines at block 410 that coherence directory 200 indicates the coherency state for the requested memory block is not Exclusive (E) for any processor 102, that is, is Shared (S) or Invalid (I) for all processors 102, the process passes through page connector B to block 440 of FIG. 4B, which is described below. If, on the other hand, PQ 204 determines at block 410 that coherence directory 204 indicates the coherency state of the requested memory block is Exclusive (E) for a particular processor 102, meaning that the memory block may be in any of the M, E, S or I states with respect to that processor 102, the process passes to block 420. It should be noted that the speculative access to memory is permitted to proceed even in the presence of an indication in coherence directory 200 that a cached copy of the target memory block is held by a processor 102 in one of L2 caches 106.

Block 420 depicts PQ 204 mastering a reflected bus read request specifying the target memory address on the processor bus 109 (e.g., processor bus 109b) of the processor 102 associated by coherence directory 200 with the E coherency state (also shown at reference numeral 218 of FIG. 2). For clarity, this processor bus 109b is referred to herein as the “alternative processor bus.” In addition, PQ 204 monitors the snoop phases on the alternative processor bus 109b (as also shown at reference numeral 220 of FIG. 2) for the snoop response to the reflected bus read request (FIG. 2, reference numeral 222) and for a collision, if any, between the target memory address of the reflected bus read request and that of another memory access request occurring prior to receipt by PQ 204 of the snoop response of the reflected bus read request.

The monitoring depicted at block 420 can have three outcomes, which are collectively represented by the outcomes of decision blocks 422 and 424. In particular, if PQ 204 determines at block 422 that the target memory address received a “dirty” snoop response to the reflected bus read request, indicating that the target address is cached in the Modified coherency state by a processor 102 on the alternative processor bus 109b, the process passes through page connector A to block 430 of FIG. 4B, which is described below. Alternatively, if PQ 204 determines at block 422 that no collision was detected and the target memory address received a “clean” snoop response to the reflected bus read request, indicating that the target address is cached, if at all, in the Shared coherency state by a processor 102 on the alternative processor bus 109b, the process passes through page connector B to block 440 of FIG. 4B, which is described below. Alternatively, in response to PQ 204 determining at block 424 that a “clean” snoop response was received for the reflected bus request and that a collision was detected for the target memory address, the process proceeds to block 426 and following blocks, which are described below.

Referring now to block 430 of FIG. 4B, which pertains to the case in which the reflected bus read request received a “dirty” snoop response, PQ 204 provides a data return indication to the requesting processor bus interface 112 to indicate that the next data it receives will be valid. As depicted at block 432, asynchronously to the transmission of the data return indication at block 430, processor bus interface 112b receives an updated copy of the requested memory block from a processor 102 on the alternative processor bus 109b (FIG. 2, reference numeral 224) and, concurrently with buffering the memory block copy within CDB 240, forwards the updated copy of memory block to the requesting processor bus interface 112a. Upon receiving both the data return indication and the requested memory block, requesting processor bus interface 112a initiates a deferred reply on processor bus 109a to complete the transaction, following the standard bus protocol. As indicated at reference numeral 228 of FIG. 2, the bus protocol provides for memory controller 110 to indicate the maximum coherency state the memory block may be assigned in the L2 cache 106 of the requesting processor 102 (e.g., S or E/M).

Following block 432, the process proceeds to block 460, which depicts PQ 204 updating the entry for the target memory address in coherence directory 200 to indicate that the requesting processor 102 holds a Shared copy of the associated memory block. Thereafter, PQ 204 deallocates the PQ entry 206 allocated to the bus read request (block 462), and the process terminates at block 464.

Referring now to block 440 of FIG. 4B, which pertains to the case in which the reflected bus read request received a “clean” snoop response, PQ 204 provides a data return indication to the requesting processor bus interface 112a to indicate that the next data it receives will be valid. As indicated at block 442, asynchronously to the transmission of the data return indication at block 440, memory interface 114 receives a copy of the requested memory block from memory subsystem 130 in response to the speculative fastpath read request and, concurrently with buffering the copy of the requested memory block within CDB 240, forwards the copy of the memory block to the requesting processor bus interface 112a (FIG. 2, reference numeral 227). Upon receiving both the data return indication and the requested memory block, processor bus interface 112a initiates a deferred reply on processor bus 109a to complete the transaction, following the standard bus protocol. As indicated at reference numeral 228 of FIG. 2, the bus protocol provides for memory controller 110 to indicate the maximum coherency state the memory block may be assigned in the L2 cache 106 of the requesting processor 102 (e.g., S or E/M).

Following block 442, the process proceeds to block 460, which depicts PQ 204 updating the entry for the target memory address in coherence directory 200 to indicate that the requesting processor 102 holds an Exclusive copy of the associated memory block. Thereafter, the process passes to blocks 462-464, which have been described.

Referring now to block 426, in response to PQ 204 determining that a “clean” snoop response was received for the reflected bus request and that a collision was detected for the target memory address data processing system 100, PQ 204 performs the necessary cleanup operations to appropriately address the collision. Two embodiments of a method of detecting collisions and performing the cleanup operations are described in detail below with reference to FIGS. 5A-5B and 6. Because the cleanup operations involve the cancellation of the speculative memory read request initiated at block 404, PQ 204 thereafter initiates a second non-speculative memory read request for the target memory address, as illustrated at block 428 of FIG. 4A and at reference numeral 226 of FIG. 2.

The process then proceeds through page connector C of FIG. 4A to block 450 of FIG. 4B. Block 450 depicts PQ 204 providing a data return indication to the requesting processor bus interface 109a to indicate that the next data it receives will be valid. As indicated at block 452, asynchronously to the transmission of the data return indication at block 450, memory interface 114 receives a copy of the requested memory block from memory subsystem 130 in response to the non-speculative read request initiated at block 428 and, concurrently with buffering the memory block within CDB 240, forwards the copy of the memory block to the requesting processor bus interface 112a. Upon receiving both the data return indication and the requested memory block, processor bus interface 112a initiates a deferred reply on processor bus 109a to complete the transaction, following the standard bus protocol. As indicated at reference numeral 228 of FIG. 2, the bus protocol provides for memory controller 110 to indicate the maximum coherency state the memory block may be assigned in the L2 cache 106 of the requesting processor 102 (e.g., S or E/M).

Following block 452, the process proceeds to block 460, which depicts PQ 204 updating the entry for the target memory address in coherence directory 200 to indicate that the requesting processor 102 holds a Shared copy of the associated memory block. Thereafter, the process passes to blocks 462-464, which have been described.

As noted above, the present invention can be realized in multiple embodiments that differ with respect to how collisions are detected between memory access requests at blocks 422 and 424 of FIG. 4A. In particular, FIG. 5A depicts a first embodiment of a method by which collision detection logic 202 of FIG. 2 imprecisely detects a collision between memory access requests by simply detecting concurrently pending requests having matching target addresses. FIG. 5B, in contrast, illustrates a second embodiment of a method by collision detection by which collision detection logic 202 precisely detects a collision between memory access requests by verifying both a target address match and a write-after-read condition.

Referring first to FIG. 5A, the imprecise method of collision detection begins at block 500 and thereafter proceeds to block 502, which depicts collision detection logic 202 iterating until a memory access request is received from request handler 208 in parallel with the presentation of the memory access request to PQ 204. In a preferred embodiment, the memory access request includes at least a transaction type indication indicating the type of memory access request and the target memory address to be accessed. In response to receipt of the memory access request, collision detection logic 202 compares the target memory address to those of the pending memory access requests within PQ 204 and determines whether or not the target address specified by the received memory access request matches the target address of a pending memory access request (block 504).

If collision detection logic 202 determines at block 504 that the target address of the reflected memory access request does not match that of one of the pending memory access requests enqueued within PQ 204, the process ends at block 512. If, on the other hand, collision detection logic 202 detects a target address match at block 504, collision detection logic 202 marks the PQ entry 206 allocated to the previously pending memory access request as having a collision by setting its collision flag 306 (block 510). It should be noted that in this imprecise first embodiment, a collision is marked regardless of whether or not the later received memory access request is a read request (in which case, no actual collision occurs) or a write request (in which case, a collision occurs). Such imprecision may be tolerated, and indeed desirable, in view of the infrequent occurrence of a target address match at block 504 and the additional complexity of the circuitry required to verify the occurrence of a read-before-write collision. Following block 510, the process ends at block 512.

Referring now to FIG. 5B, a high level logical flowchart of an exemplary precise method by which collision detection logic 202 detects a collision between a newly received memory access request and a previously pending memory access request is depicted. The process of FIG. 5B begins at block 530 and proceeds to block 522, which depicts collision detection logic 202 iterating until a memory access request is received from request handler 208 in parallel with the presentation of the memory access request to PQ 204. As noted above, the memory access request preferably includes at least a transaction type indication indicating the type of memory access request and the target memory address to be accessed. In response to receipt of the memory access request, collision detection logic 202 compares the target memory address to those of the pending memory access requests within PQ 204 and determines whether or not the target address specified by the received memory access request matches the target address of a pending memory access request (block 524).

If collision detection logic 202 determines at block 524 that the target address of the reflected memory access request does not match that of one of the pending memory access requests enqueued within PQ 204, the process ends at block 540. If, on the other hand, collision detection logic 202 detects a target address match at block 524, collision detection logic 202 temporarily buffers the key of the PQ entry 206 allocated to the memory access request having the matching target address (block 530). Next, at block 532, collision detection logic 202 determines whether or not the memory access request received at block 522 generated a write to memory subsystem 130. The memory access request generates a memory write if the transaction type indicates a write or if a processor 102 provides a “dirty” (e.g., Modified) snoop response during the snoop phase of the memory access request. In response to a negative determination at block 532, the process proceeds to block 536, which is described below. If, however, collision detection logic 202 determines that the memory access request generated a memory write, collision detection logic marks the PQ entry 206 identified by the buffered PQ key as having a collision by setting its collision flag 306 (block 534).

Following block 534 (or following a negative determination at block 532), collision detection logic 202 discards the buffered PQ key at block 536. Thereafter, the process ends at block 540.

With reference now to FIG. 6, there is depicted a high level logical flowchart of an exemplary method by which memory controller 110 performs cleanup operations in response to an indication that a collision has occurred for a pending memory access request in accordance with the present invention. PQ 204 performs the illustrated process for an individual PQ entry 206 at block 426 of FIG. 4A.

The process begins at block 600 in response to allocation of a PQ entry 206 and then proceeds to block 602, which depicts PQ 204 monitoring the state of the collision flag 306 of the PQ entry 206. If no collision is indicated by collision flag 306, the process continues to iterate at block 602 until a collision flag 306 is set at block 510 of FIG. 5A (or block 534 of FIG. 5B for precise implementations) or until the PQ entry 206 is deallocated. In response to collision flag 306 being set by collision detection logic 202, PQ 204 resets the buffer of the requesting processor 102 within process bus interface 112 to discard the copy of the target memory block, if any, obtained by the speculative fastpath read (block 604). Similarly, at block 606, PQ 204 resets the memory data valid field 304 of the PQ entry 206 to invalidate the copy of the target memory block, if any, buffered within CDB 240. Further, at block 608, PQ 204 cancels the speculative fastpath memory read in case it is yet to be performed by memory interface 114. Thereafter, the cleanup process depicted in FIG. 6 ends at block 610.

With reference now to FIG. 7, there is illustrated is high level logical flowchart of an exemplary method of efficiently performing an eviction from coherence directory 200 in accordance with the present invention. As described above, the eviction process depicted in FIG. 7 is performed at block 414 of FIG. 4A in response to a miss in coherence directory 200 that necessitates replacement of an entry to accommodate a new coherence directory entry for the target memory address of a memory access request.

The illustrated process begins at block 700 and thereafter proceeds to block 702, which depicts coherence directory 200 selecting a victim entry from among the set of directory entries to which the target memory address of the newly received memory access request is indexed and transmitting the contents of the victim entry from the directory array to a sequencer 201 within coherence directory 200. As noted above, coherence directory 200 may select the victim entry utilizing any of a number of well-known replacement policies, such as random, round-robin, least recently used (LRU), most recently used (MRU), etc. Transferring the line to be evicted to sequencer 201 allows the allocation of a new entry in coherence directory 200 as shown at block 412 of FIG. 4A and the eviction of the victim entry from coherence directory 200 to be performed asynchronously. Thus, as long as there is an available sequencer 201, a memory access request that causes a miss in coherence directory 200 may proceed.

In response to receipt of the victim entry, sequencer 201 issues a back-invalidate request to request handler 208, as depicted at block 704 of FIG. 7 and at reference numeral 230 of FIG. 2. The back-invalidate request, which preferably includes the coherency information for the victim entry, requests the invalidation of all cached copies of the memory block identified by the victim memory address associated with the victim entry of coherence directory 200. While the back-invalidate request is pending, sequencer 201 continues to receive and apply coherency updates to the victim entry.

As with other requests, the back-invalidate request of sequencer 201 is processed by request handler 208 and then presented in parallel to PQ 204 and coherence directory 200 (block 706). In response to receipt of the back-invalidate request, PQ 204 allocates a PQ entry 206 to the back-invalidate request and issues a speculative back-invalidate command on each processor bus 109 indicated by the coherency information contained in the back-invalidate request as having a processor 102 attached that is caching a copy of the victim memory block (block 708). The back-invalidate command(s) issued at block 708 are speculative in that there can be a time interval between sequencer 201 presenting the back-invalidate to request handler 208 and the back-invalidate request being accepted by PQ 204. During this time interval, which occurs during block 706 and is lengthened by any queuing present in requested handler 208, directory updates are not propagated to the in-flight back-invalidate request, but are instead applied by sequencer 201. Consequently, when PQ 204 receives the back-invalidate request, PQ 204 must assume the directory states contained within the back-invalidate request are stale and must perform a lookup in coherence directory 200 to verify correctness. Thus, any back-invalidate command(s) issued prior to receipt by PQ 204 of the coherency information for the pending back-invalidate request from coherence directory 200 are speculative.

Thereafter, at block 712, PQ 204 receives from coherence directory 200 the coherency information for the pending back-invalidate request. In response, PQ 204 determines at block 714 whether or not the set of speculative back-invalidate commands issued at block 708 was under-inclusive, that is, whether the coherency information received at block 712 indicates one or more additional processor buses 109 on which a back-invalidate command must be transmitted. If not, the process passes to block 722, which is described below. If, however, PQ 204 determines at block 714 that one or more additional back-invalidate commands are required to invalidate all cached copies of the memory block corresponding to the victim entry, PQ 204 issues the required non-speculative back-invalidate commands at block 716.

As shown at blocks 722 and 724, once the snoop phases for all of the back-invalidate command(s) have been received, thus confirming invalidation of all cached copies of the memory block corresponding to the victim entry, coherence directory 200 retires the sequencer 201 allocated to the eviction process. As indicated at blocks 724 and 726, the PQ entry 206 allocated to the back-invalidate request is subsequently retired when any memory writes occasioned by the back-invalidation of a modified copy of the victim memory block and all bus phases associated with the back-invalidate request have completed. Thereafter, the process terminates at block 730.

As has been described, the present invention provides improved methods, apparatus and systems for data processing. According to one aspect of the present invention, a read request is serviced efficiently within a multiprocessor data processing system implementing a directory-based coherency protocol by initiating a speculative access to a memory subsystem and permitting the speculative access to proceed even in the presence of an indication in a central coherence directory that the requested memory block is cached at a processor in the data processing system. By permitting the speculative access to proceed, memory access latency is reduced in cases in which the indication in the central coherence directory was incorrect. The disclosed method reduces memory access latency even in the presence of potential or actual write-after-read collisions.

According to a second embodiment of the present invention, the central coherence directory preferably contains fewer entries than the number of memory blocks within the memory subsystem. When a back-invalidate request is received indicating that an entry needs to be evicted from the central coherence directory to permit the allocation of a new entry, a set of one or more speculative back-invalidate command(s) is issued on one or more processor bus(es) prior to receipt from the central coherence directory of the coherency information for the back-invalidate request. When the coherency information for the back-invalidate request is received from the central coherence directory, one or more additional back-invalidate commands are issued if the set of speculative back-invalidate commands was under-inclusive. In this manner, eviction from the central coherence directory is efficiently performed.

While the invention has been particularly shown as described with reference to a preferred embodiment, it will be understood by those skilled in the art that various changes in form and detail may be made therein without departing from the spirit and scope of the invention. For example, although aspects of the present invention have been described with respect to a data processing system hardware components that perform the functions of the present invention, it should be understood that present invention may alternatively be implemented partially or fully in software or firmware program code that is processed by data processing system hardware to perform the described functions. Program code defining the functions of the present invention can be delivered to a data processing system via a variety of computer-readable media, which include, without limitation, non-rewritable storage media (e.g., CD-ROM or non-volatile memory), rewritable storage media (e.g., a floppy diskette or hard disk drive), and communication media, such as digital and analog networks. It should be understood, therefore, that such computer-readable media, when carrying or encoding computer readable instructions that direct the functions of the present invention, represent alternative embodiments of the present invention.

What is claimed is:

1. A method of servicing a data access request in a multiprocessor data processing system including multiple processors, a memory controller controlling access to a memory subsystem, multiple processor buses coupled to the memory controller, and at least one of the multiple processors coupled to each processor bus, said method comprising:
in response to receiving a first read request of a first processor via a first processor bus, said first read request specifying a target address of a target memory block, the memory controller initiating a speculative access to the target memory block in the memory subsystem and initiating a lookup of the target address in a central coherence directory that records cache states of the multiple processors with respect to memory blocks of the memory subsystem;
in response to said central coherence directory indicating that a copy of the target memory block is cached by a second processor coupled to a second processor bus, the memory controller transmitting a second read request on the second processor bus, said second read request specifying the target address; and
in response to receiving a clean snoop response to said second read request on said second processor bus, the memory controller providing to the first processor the target memory block retrieved from the memory subsystem by the speculative access.

2. The method of claim 1, wherein said central coherence directory indicates that the target memory block is possibly modified with respect to the memory subsystem in response to the lookup of the target address.

3. The method of claim 1, and further comprising:
in response to a dirty snoop response to the second read request, the memory controller:
discarding the target memory block retrieved from the memory subsystem by the speculative access;
receiving a copy of the target memory block from the second processor in response to the second read request on the second processor bus; and
providing to the first processor the copy of the target memory block received from the second processor.

4. The method of claim 1, and further comprising:
the memory controller monitoring to detect a collision for the first read request prior to receipt of the snoop response for the second read request;
in response to detecting a collision for the first read request, the memory controller discarding any data obtained by the speculative access and initiating a non-speculative access to the memory subsystem; and
the memory controller providing to the first processor the target memory block retrieved from the memory subsystem by the non-speculative access to the memory subsystem.

5. The method of claim 4, wherein said monitoring comprises imprecisely monitoring to detect a collision by comparing the target address of the first read request with target addresses of one or more other memory access requests received by the memory controller.

6. The method of claim 4, wherein said monitoring comprises precisely monitoring to detect a write-after-read collision for the target address.

7. A multiprocessor data processing system, comprising:
multiple processors including a first processor and a second processor;
a first processor bus coupled to said first processor and a second processor bus coupled to said second processor;
a memory subsystem; and
a memory controller coupled to the first processor bus, the second processor bus, and the memory subsystem, said memory controller including a central coherence directory that records cache states of the multiple processors with respect to memory blocks of the memory subsystem, wherein said memory controller, responsive to receiving a first read request of the first processor via the first processor bus, said first read request specifying a target address of a target memory block, initiates a speculative access to the target memory block in the memory subsystem and initiates a lookup of the target address in the central coherence directory, and wherein said memory controller, responsive to said central coherence directory indicating that a copy of the target memory block is cached by the second processor, transmits on the second processor bus a second read request specifying the target address, and wherein said memory controller, responsive to receiving a clean snoop response to said second read request on said second processor bus, provides to the first processor the target memory block retrieved from the memory subsystem by the speculative access.

8. The data processing system of claim 7, wherein said central coherence directory indicates that the target memory block is possibly modified with respect to the memory subsystem in response to the lookup of the target address.

9. The data processing system of claim 7, wherein the memory controller, responsive to a dirty snoop response to the second read request, discards the target memory block retrieved from the memory subsystem by the speculative access, receives a copy of the target memory block from the second processor in response to the second read request on the second processor bus, and provides to the first processor the copy of the target memory block received from the second processor.

10. The data processing system of claim 7, wherein the memory controller monitors to detect a collision for the first read request prior to receipt of the snoop response for the second read request, and response to a detection thereof, discards any data obtained by the speculative access, initiates a non-speculative access to the memory subsystem, and provides to the first processor the target memory block retrieved from the memory subsystem by the non-speculative access to the memory subsystem.

11. The data processing system of claim 10, wherein said memory controller imprecisely monitors to detect a collision by comparing the target address of the first read request with target addresses of one or more other memory access requests received by the memory controller.

12. The data processing system of claim 10, wherein said memory controller precisely monitors to detect a write-after-read collision for the target address.

13. A memory controller for a multiprocessor data processing system containing multiple processors including a first processor and a second processor, a first processor bus coupled to the first processor, a second processor bus coupled to said second processor, and a memory subsystem, said memory controller comprising:
a processor bus interface coupled to the first and second processor buses;
a memory interface coupled to the memory subsystem;
a central coherence directory that records cache states of the multiple processors with respect to memory blocks of the memory subsystem; and
a pending queue that services memory access request, wherein said pending queue, responsive to receiving a first read request of the first processor via the first processor bus, said first read request specifying a target address of a target memory block, initiates a speculative access to the target memory block in the memory subsystem and initiates a lookup of the target address in the central coherence directory, and wherein said pending queue, responsive to said central coherence directory indicating that a copy of the target memory block is cached by the second processor, transmits on the second processor bus a second read request specifying the target address, and wherein said pending queue, responsive to receiving a clean snoop response to said second read request on said second processor bus, provides to the first processor the target memory block retrieved from the memory subsystem by the speculative access.

14. The memory controller of claim 13, wherein said central coherence directory indicates that the target memory block is possibly modified with respect to the memory subsystem in response to the lookup of the target address.

15. The memory controller of claim 13, wherein the memory controller, responsive to a dirty snoop response to the second read request, discards the target memory block retrieved from the memory subsystem by the speculative access, receives a copy of the target memory block from the second processor in response to the second read request on the second processor bus, and provides to the first processor the copy of the target memory block received from the second processor.

16. The memory controller of claim 7, wherein the memory controller includes collision detection logic that monitors to detect a collision for the first read request prior to receipt of the snoop response for the second read request, and wherein, responsive to a detection of a collision, the memory controller discards any data obtained by the speculative access, initiates a non-speculative access to the memory subsystem, and provides to the first processor the target memory block retrieved from the memory subsystem by the non-speculative access to the memory subsystem.

17. The memory controller of claim 16, wherein said collision detection logic imprecisely monitors to detect a collision by comparing the target address of the first read request with target addresses of one or more other memory access requests received by the memory controller.

18. The memory controller of claim 16, wherein said collision detection logic precisely monitors to detect a write-after-read collision for the target address.

19. A program product for servicing a data access request in a multiprocessor data processing system including multiple processors, a memory controller controlling access to a memory subsystem, multiple processor buses coupled to the memory controller, and at least one of the multiple processors coupled to each processor bus, said program product comprising:
a tangible computer readable medium; and
program code stored within the tangible computer readable medium that causes the memory controller to perform a method including:
in response to receiving a first read request of a first processor via a first processor bus, said first read request specifying a target address of a target memory block, initiating a speculative access to the target memory block in the memory subsystem and initiating a lookup of the target address in a central coherence directory that records cache states of the multiple processors with respect to memory blocks of the memory subsystem;
in response to said central coherence directory indicating that a copy of the target memory block is cached by a second processor coupled to a second processor bus, transmitting a second read request on the second processor bus, said second read request specifying the target address; and
in response to receiving a clean snoop response to said second read request on said second processor bus, providing to the first processor the target memory block retrieved from the memory subsystem by the speculative access.

20. The program product of claim 19, wherein said central coherence directory indicates that the target memory block is possibly modified with respect to the memory subsystem in response to the lookup of the target address.

21. The program product of claim 19, wherein the method further comprises:
in response to a dirty snoop response to the second read request, the memory controller:
discarding the target memory block retrieved from the memory subsystem by the speculative access;
receiving a copy of the target memory block from the second processor in response to the second read request on the second processor bus; and
providing to the first processor the copy of the target memory block received from the second processor.

22. The program product of claim 19, the method further comprising:
the memory controller monitoring to detect a collision for the first read request prior to receipt of the snoop response for the second read request;
in response to detecting a collision for the first read request, the memory controller discarding any data obtained by the speculative access and initiating a non-speculative access to the memory subsystem; and
the memory controller providing to the first processor the target memory block retrieved from the memory subsystem by the non-speculative access to the memory subsystem.

23. The program product of claim 22, wherein said monitoring comprises imprecisely monitoring to detect a collision by comparing the target address of the first read request with target addresses of one or more other memory access requests received by the memory controller.

24. The program product of claim 22, wherein said monitoring comprises precisely monitoring to detect a write-after-read collision for the target address.
